(19) United States
(12) Patent Application Publication
(10) Pub. No.: US 2022/0253695 A1
(43) Pub. Date: Aug. 11, 2022

(54) PARALLEL CASCADED NEURAL NETWORKS

(71) Applicant: Google LLC, Mountain View, CA (US)

(72) Inventors: Michael Curtis Mozer, Mountain View, CA (US); Michael Louis Iuzzolino, Redmond, WA (US); Samuel Bengio, Los Altos, CA (US)

(21) Appl. No.: 17/560,139

(22) Filed: Dec. 22, 2021

Related U.S. Application Data
(60) Provisional application No. 63/146,545, filed on Feb. 5, 2021.

(51) Int. Cl. G06N 3/08

(52) U.S. Cl. CPC G06N 3/08

(57) ABSTRACT

Methods, systems, and apparatus, including computer programs encoded on computer storage media, for processing a network input using a parallel cascaded neural network that includes multiple neural network blocks that each have a skip connection and a propagation delay. Methods, systems, and apparatus, including computer programs encoded on computer storage media, for training parallel cascaded neural networks using temporal difference learning are also described.

### CROSS-REFERENCE TO RELATED APPLICATION

This application claims priority to U.S. Provisional Application No. 63/146,545, filed on Feb. 5, 2021. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that uses a parallel cascaded neural network to process an input to generate an output. The parallel cascaded neural network receives a network input and generates candidate network outputs for the network input at each of multiple time steps by propagating information through the neural networks by use of skip connections.

Particular embodiments of the subject matter described in this specification can be implemented so as to realize one or more of the following advantages.

This specification describes neural networks that have cascaded dynamics, where information propagates from neurons at all layers in parallel but transmission is gradual over time. This is in contrast to conventional deep neural networks, which have sequential dynamics, wherein each layer fully completes its computation before processing begins in subsequent layers. In particular, the described cascaded neural networks are made up of multiple neural network blocks that each have a propagation delay on their learned transformation but that propagate information through skip connections without delay. As a result, the functional depth of the architecture increases over time and yields a trade-off between processing speed and accuracy. That is, the cascaded neural networks can generate predictions with greatly reduced latency relative to similar sized, sequential deep neural networks and, depending on available computational and latency budget, refine those predictions over subsequent time steps. Thus, the cascaded neural networks described in this specification are particularly well adapted for deployment in environments with strict latency requirements, e.g., on-board autonomous vehicles or on-board robotic agents. Moreover, the sequence of outputs generated by the cascaded neural network can jointly be used to detect whether any given input is an out-of-distribution (OOD) input, i.e., an input that is not similar to the inputs that were included in the training data of the model, and therefore may result in the neural network generating an inaccurate output. Detection is more accurate when using the multiple candidate network outputs for the time steps in the sequence than with the single output produced by a standard network with sequential dynamics. This makes the cascaded neural network well-suited for deployment in environments where OOD detection is particularly important, e.g., for use in processing medical images.

This specification also describes the use of a temporal-difference training objective for such neural networks that results in the predictions made at early time steps being of significantly higher quality than when the cascaded neural networks are trained using conventional techniques.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example neural network system.

FIG. 1B shows the processing performed by a parallel cascaded neural network that includes a set of one or more initial layers with a delay component, layer blocks and output head over five time steps.

FIG. 2 is a flow diagram of an example process for processing a network input using the parallel cascaded neural network.

FIG. 3 is a flow diagram of an example process for processing a block input using a layer block.

FIG. 4 is a flow diagram of an example process for training the parallel cascaded neural network.

Like reference numbers and designations in the various drawings indicate like elements.

### DETAILED DESCRIPTION

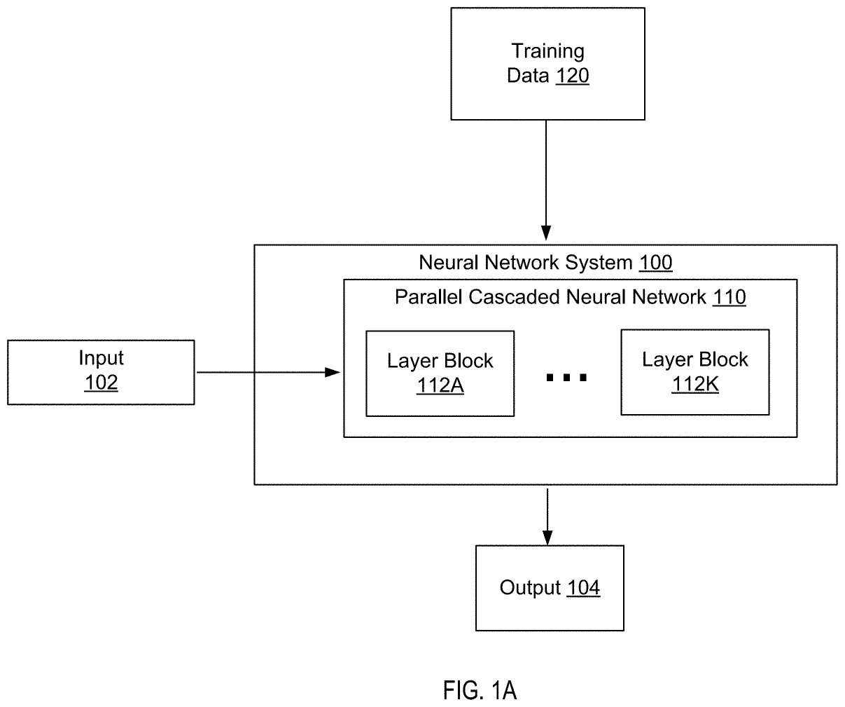

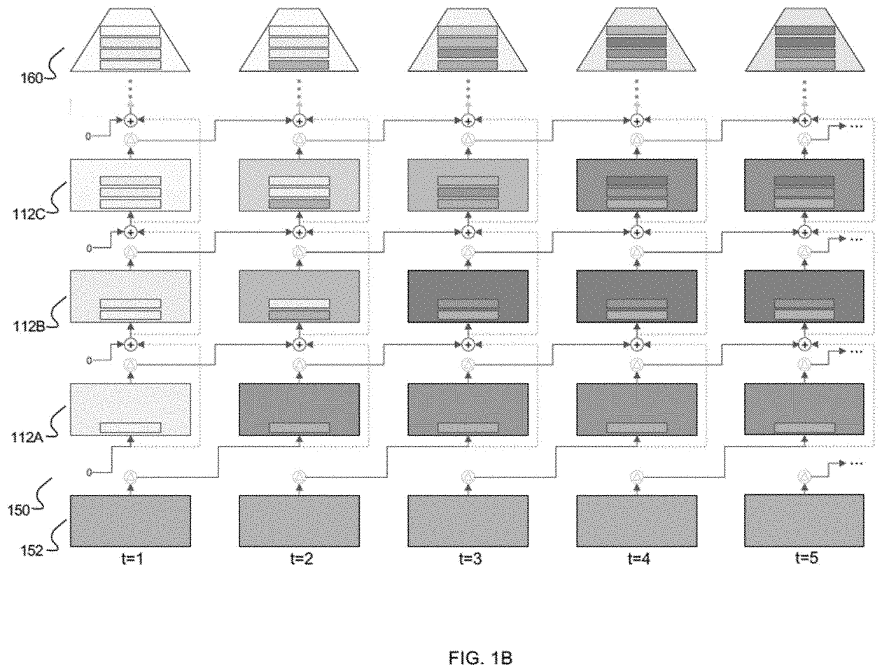

FIG. 1A shows an example neural network system 100. The neural network system 100 is an example of a system implemented as computer programs on one or more computers in one or more locations, in which the systems, components, and techniques described below can be implemented.

The neural network system 100 uses a parallel cascaded neural network 110 to perform a machine learning task, i.e., to process network inputs to generate network outputs for the machine learning task.

The neural network 110 can be configured through training to perform any kind of machine learning task, i.e., can be configured to receive any kind of digital data input and to generate any kind of classification output or regression output based on the input. A classification output is one that includes one or more score distributions over a set of classes for each input. A regression output is one that specifies one or more continuous scalar or vector values.

In some cases, the neural network is a neural network that is configured to perform a computer vision task, i.e., receive a network input that includes one or more images and to process the network input to generate a network output for the input image.

The one or more input images can be any appropriate type of image. For example, the image can be a two-dimensional image, e.g., a two-dimensional image that has multiple channels (e.g., an RGB image). As another example, the image can be a hyperspectral image that represents a continuous spectrum of wavelengths, e.g., by identifying, for each pixel in the image, a distribution over the spectrum. As another example, the image can be a point cloud that includes multiple points, where each point has a respective coordinate, e.g., in a three-dimensional or a higher-dimensional coordinate space; as a particular example, the image can be a point cloud generated by a LIDAR sensor. As another example, the image can be a medical image generating by a medical imaging device; as particular examples, the image can be a computer tomography (CT) image, a magnetic resonance imaging (MM) image, an ultrasound image, an X-ray image, a mammogram image, a fluoroscopy image, or a positron-emission tomography (PET) image.

In some cases the one or more images are static over time, i.e., there is a single set of one or more images that is provided as input to the neural network 110.

In some other cases, the one or more images change over time. As a particular example, the network input can be a video that includes a respective image at each of multiple time steps. As yet another example, the network input can be multiple images of a scene in an environment, e.g., taken at different times or from different viewpoints.

For example, the task may be image classification, and the output generated by the neural network for a given image may be scores for each of a set of object categories, with each score representing an estimated likelihood that the image contains an image of an object belonging to the category.

As yet another example, the task can be image segmentation and the output generated by the neural network can include, for each pixel of each input image, scores for each of a set of object categories, with each score representing an estimated likelihood that the portion of the image depicted at that pixel is part of an image of an object belonging to the category.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, the task may be an audio processing task. For example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

In some implementations, for any of the above tasks, the network output 104 also includes an out-of-distribution (OOD) estimate that is an estimate of whether the network input 102 is an OOD input. An OOD input is an input that is drawn from a different distribution than the training data that was used to train the neural network 110, i.e., is dissimilar to any of the training inputs in the training data.

Generally, the neural network 110 has an architecture in which a subset of the neural network layers are arranged into a stack of layer blocks 112A-K. A layer block, as used in this specification, refers to a group of one or more neural network layers in a neural network.

More specifically, the parallel cascaded neural network 110 can have any appropriate architecture that includes multiple neural network blocks 112A-K arranged in a stack, with each of the neural network blocks 112A-K having (i) a skip connection and (ii) a delay component.

A skip connection combines the input to the block 112A-K with the output of a learned block transformation (applied to the block input) as part of generating the output of the block. For example the block output can be the sum of the block input and the output of the learned block transformation. As another example, the block output can be can be the output of a non-linearity, e.g., ReLU, applied to the sum of the block input and the output of the learned block transformation applied to the skip connection.

The learned block transformation is generally the output of one more layers within the neural network block 112A-K that is generated by processing the block input to the block 112A-K.

One example of a learned block transformation includes multiple convolutions each separated by a non-linearity, e.g., a ReLU, a normalization layer, or both. Other examples can include a self-attention layer (optionally followed by or preceded by a normalization layer) and fully-connected layers (optionally followed by or preceded by a normalization layer).

The delay component within each block 112A-K delays the transmission of signals from the output of the learned block transformation within the block 112A-K.

That is, while processing a given network input, the neural network 110 processes for multiple time steps, i.e., for each time step in a sequence that starts from a first time step and continues for multiple time steps until reaching a final time step. A time step, as used in this specification, refers to a unit of time, processor cycles, or other unit of computing resources during which the processing happens in parallel, i.e., all of the operations that are performed at the time step are performed after all of the operations at the preceding time step and before all of the operations at the following time steps.

When there are no delay components, i.e., when the neural network has conventional dynamics, the system performs the processing of different blocks at different time steps. That is, the system performs the processing of the blocks sequentially and the network output of the neural network, i.e., the output of the output layer of the neural network, is only generated at the final time step.

However, using the described techniques, at least some of the operations of two or more of the blocks can be performed at the same time step.

In particular, the delay component within each block operates on the transform history, i.e., on the outputs of the learned block transformation over one or more previous time steps and, in some cases, the output of the learned block transformation at the current time step, to generate the final output of the learned block transformation for the time step, i.e., the output that will combined with the block input at the time step.

As will be seen from the description below with reference to FIGS. 1B, 2 and 3, the delay component within each block ensures that the complete output of the learned block transformation performed by the block is not propagated to the next block in the stack until one or more time steps after the output is initially generated.

As a particular example, when the neural network 110 is a convolutional neural network, the architecture of the neural network 110 can include one or more initial convolutional layers that process the network input to generate an initial convolutional output, followed by the stack of blocks 112A-K that process the initial convolutional output to generate a final block output, and an output head that includes one or more neural network layers, e.g., one or more fully-connected layers followed by a softmax layer, that generate the network output for the network input.

In some implementations, the one or more initial convolutional layers also have a delay component but do not have a skip connection. In some other implementations, the one or more initial convolutional layers do not have a delay component and do not have a skip connection.

More generally, the neural network 110 can be adapted from any type of neural network architecture that has a skip connection, e.g., Highway Nets, DenseNets, U-Nets, or Transformers, by adding a propagation delay to the blocks within the architecture that have a skip connection. That is, for each skip connection, the components around which the skip connection is applied can be modified so that their outputs are only available with a temporal delay, i.e., are modulated with a delay component before being provided as input to the skip connection.

Prior to using the neural network 110 to process new network inputs, the system 100 or another training system trains the neural network 110 on training data 120.

The training data 120 includes a plurality of training examples, with each training example including a training network input and a target output for the training network input. The target output is an output that should be generated by performing the machine learning task on the training network input, i.e., is the ground truth output for the machine learning task for the training network input.

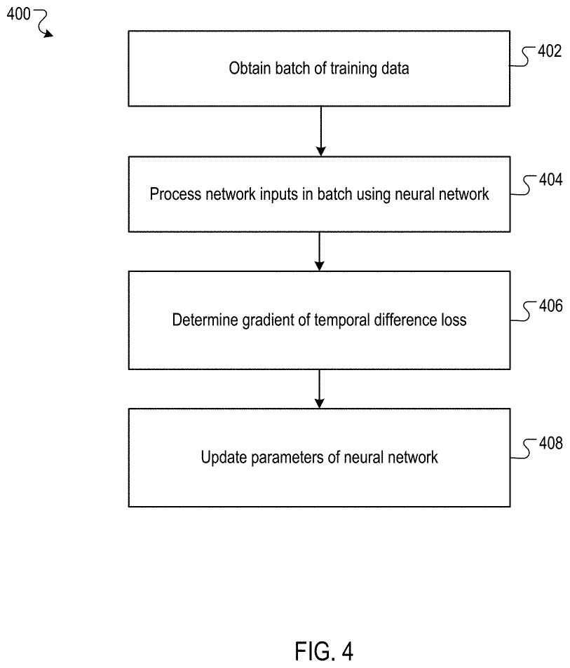

One example technique for training the neural network 110 is described below with reference to FIG. 4.

FIG. 1B shows the processing performed by a parallel cascaded neural network 110 that includes a set of one or more initial layers with a delay component 150, layer blocks 112A, 112B, and 112C, and output head 160 over five time steps t=1, 2, 3, 4, and 5.

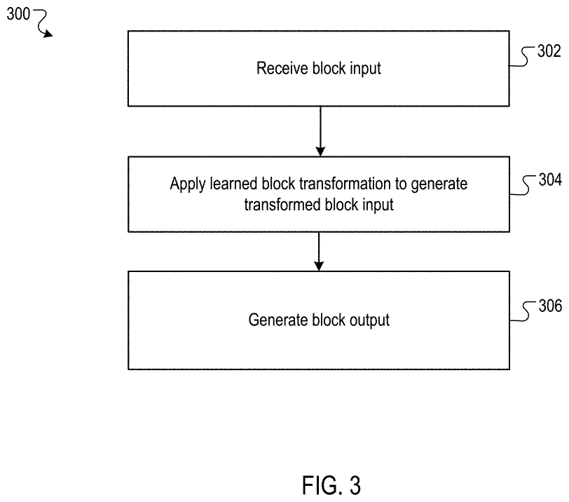

In the example of FIG. 1B, the delay component causes the output of the learned transform of each block 112A-112C to be delayed by one time step before being provided to the skip connection of the block. Similarly, the output of the initial layer(s) is delayed by one time step due to the delay component 150 of the initial layer(s). This form of delay will be referred to as One-Step Delay (OSD). Alternative forms of delay components are described below with reference to FIG. 3.

Thus, at time step t=1, the neural network 110 receives an input and processes the input using the set of one or more initial layers to generate an initial output 152. However, due to the delay component 152 and because the initial layers do not have a skip connection, the output 152 is not available to blocks 112A-C until time step t=2. Instead, each block 112A-112C passes a respective initial state (in this case, a state of all zeros) up through the skip connection of the block to the next block. Thus, at the first time step, the output head 160 can generate a candidate network output, but this output has no information about the network input. If the initial layer does not have a delay component, the blocks 112A-112C can pass the initial output 152 through their respective skip connections to the output head 160, but no outputs from any learned transformations applied by any of the blocks 112A-112C would be reflected in the input to the output head 160. Additionally, with alternative forms of delay components, e.g., an exponentially weighted smoothing (EWS) delay, that provide partial information about the output of the learned transformation at the current time step, the input to the output head 160 can reflect some (incomplete) information about the outputs of the learned transforms.

At time step t=2, the initial output 152 from time step t=1 is available to block 112A and then to blocks 112B and 112C through the skip connections of the blocks. Each block 112A-C applies the learned transform for the block to the initial output 152 to generate an output. However, due to the delay components of blocks 112A-C, their output is not available to subsequent blocks until step t=3. But, because of the skip connections, the initial output 152 is provided as input to the output head 160 and the output head 160 can generate a candidate network output for the time step t=2 that is based on information from the network input. Thus, after time step t=2, information has fully propagated through the block 112A, i.e., block 112A has generated a saturated output that will not change so long as the network input is static, but this information has not yet propagated to blocks 112B and 112C and these blocks have therefore not reached saturation, i.e., have not yet generated an output that will not change so long as the network input is static.

At time step t=3, the saturated output of block 112A, i.e., the combination of the output of learned block transform of block 112A with the initial output 152, is provided through the skip connection of block 112A to blocks 112B and 112C. Block 112B then applies the learned transform for the block to the saturated input. However, due to the delay components of blocks 112B, this output is not available to subsequent blocks until time step t=4. Instead, the saturated output of block 112A is provided through the skip connection after being combined with the previous output of the learned block transform of blocks 112B and 112C that was computed at time step t=2. Thus, block 112C is still provided with incomplete information and information has not yet propagated all the way through the blocks 112A-C as of time step t=3. However, the output block 160 now has more information about the network input and can therefore generate a more informed candidate network output at time step t=3 than was generated at time step t=2.

At time step t=4, the saturated output of block 112B is provided through the skip connection of block 112B to block 112C. Block 112C then applies the learned transform for the block to the saturated output. However, due to the delay components of blocks 112C, this output is not available until time step t=5. Instead, the saturated output of block 112B is provided through the skip connection after being combined with the previous output of the learned block transform of block 112C that was computed at time step t=3. Thus, the output block is still provided with incomplete information and information has not yet propagated all the way to the output block 160 as of time step t=4.

Thus, as can be seen from FIG. 1B, more information from more learned block transforms propagates to the output head 160 at each time step. However, because some information about the network input is available at each time step after the first time step, the output head 160 can begin making potentially accurate predictions starting from the second time step.

Moreover, in some implementations, each block is deployed on a respective dedicated hardware device for the block. For example, each block can be deployed on a different hardware accelerator, e.g., a GPU or a TPU. The initial neural network layer(s) and the output head can either be deployed on the same dedicated hardware as one of the blocks or can be deployed on separate dedicated hardware devices. In these implementations, the operations performed at each time step can be performed in parallel for each of the blocks (once information is passed through the skip connections). Thus, the candidate network outputs, e.g., at time steps t=2, 3 and 4 of FIG. 1B can be generated much quicker than in a conventional neural network with no delay components, where a network output is only available at time step t=5.

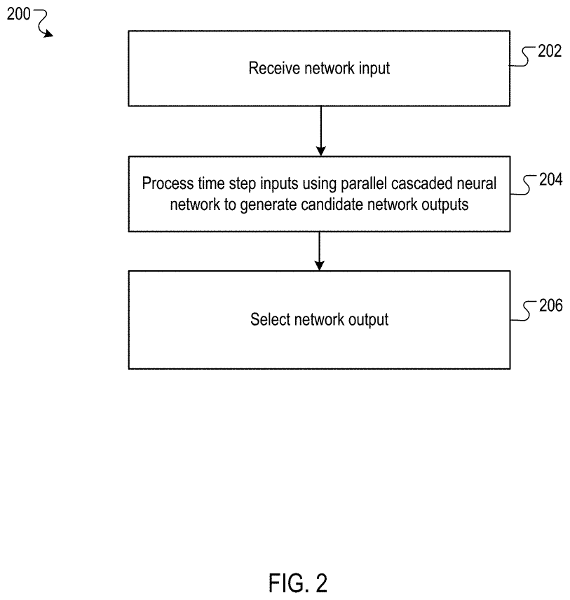

FIG. 2 is a flow diagram of an example process 200 for processing a network input using the parallel cascaded neural network. For convenience, the process 200 will be described as being performed by a system of one or more computers located in one or more locations. For example, a neural network system, e.g., the neural network system 100 of FIG. 1A, appropriately programmed, can perform the process 200.

The system receives a network input (step 202). For example, the network input can be static, e.g., a single image. As another example, the network input can be an input that changes over time. As a particular example, the network input can be a video that includes a respective image at each of multiple time steps. As yet another example, the network input can be multiple images of a scene in an environment, e.g., taken at different times or from different viewpoints.

At each time step of a time step sequence that includes a plurality of time steps, the system processes a time step input for the time step that is derived from the network input using the cascaded parallel neural network to generate a candidate network output for the time step (step 204).

Generally, at each time step, the parallel cascaded neural network processes a respective block input for the time step using each of the layer blocks within the parallel cascaded neural network to generate the candidate network output for the time step.

Processing a block input using a layer block at a given time step is described in more detail below with reference to FIG. 3.

In some cases, the sequence includes a fixed number of time steps, i.e., the system process for the same, fixed number of time steps for every network input.

In some other cases, at each time step, the system determines whether criteria for terminating processing of the network input have been satisfied and, if the criteria are satisfied, sets the time step as the last time step in the sequence, i.e., determines not to process for any additional time steps.

In some implementations, at any given time step, the system can determine whether the criteria for terminating processing of the network input have been satisfied from (i) the candidate network outputs, (ii) intermediate logits generated by the parallel cascaded neural network, or both for at least some of the time steps in the sequence.

For example, the system can process an input derived from (i) the candidate network outputs, (ii) intermediate logits generated by the cascaded neural network, or both for at least some of the time steps in the sequence using a meta-cognitive machine learning model that has been trained to predict whether the last candidate network output should be selected as the network output.

In some other implementations, the system determines that the criteria for terminating processing are satisfied when a latency budget for generating the network output has consumed, i.e., a maximum latency threshold has been met.

The system generates the network output from at least one of the candidate network outputs (step 206).

For example, the system can use only the candidate network output for the last time step in the sequence as the network output.

As another example, when the network output includes an estimate of whether the network input is an OOD input, the system can generate the estimate from the candidate network outputs at some or all of the time steps, the intermediate logits for some or all of the time steps, or both. That is, the system can detect, based on (i) the candidate network outputs, (ii) intermediate logits generated by the cascaded neural network, or both for at least some of the time steps in the sequence, whether the network input is an out-of-distribution (OOD) input.

For example, the system can process a temporal trace input derived from the network outputs for all of time steps using an OOD detector machine learning model, e.g., a fully-connected feedforward neural network, that processes the temporal trace input to generate an estimate of whether the network input is an OOD input or not. In some cases, the temporal trace input can identify, for each time step, the score in the highest scoring class in the candidate network output for the time step. In some other cases, the temporal trace input can identify, for each time step, (2) the entropy of the candidate network output for the time step, (3) the candidate network output for the time step, or (4) intermediate logits generated by the parallel cascaded neural network at the time step.

In some implementations, the system can provide the candidate network output from one of the time steps as an initial network output, e.g., the candidate network output generated once a latency budget has consumed, and then can provide a subsequent output from a subsequent time step as an updated network output if there has been a significant change from the output that was provided as the initial network output.

FIG. 3 is a flow diagram of an example process 300 for processing a block input using one of the neural network blocks in the parallel cascaded neural network at a particular time step. For convenience, the process 300 will be described as being performed by a system of one or more computers located in one or more locations. For example, a neural network system, e.g., the neural network system 100 of FIG. 1A, appropriately programmed, can perform the process 300.

The system receives the block input for the neural network block for the particular time step (step 302).

For example, for each block that is not the first block in the stack, the block input can be the block output generated by the preceding neural network block in the stack at the time step.

For the first block in the stack, the input that is used as the block input depends on the configuration of the parallel cascaded neural network.

In some implementations, the block input for the first block in the stack is the output of one or more initial layers of the neural network for the time step and generated by processing the time step input for the time step.

In some other implementations, i.e., when the initial layers do not have a delay component, the block input for the first block in the stack is the output of one or more initial layers of the neural network for the immediately preceding time step and generated by processing the time step input for the immediately preceding time step.

In yet other implementations, i.e., when the initial layers have an EWS delay component, the block input for the first block in the stack is a combination of, e.g., a sum, average, or concatenation of, (i) the output of one or more initial layers of the neural network for the time step and generated by processing the time step input for the time step and (ii) respective outputs of the one or more initial layers of the neural network for one or more preceding time steps that are each generated by processing the time step input for the preceding time step.

The system applies a learned block transformation to the block input for the particular time step to generate a transformed block input for the particular time step (step 304).

The system generates a block output for the particular time step (step 306). In general, the system generates the block output by combining at least (i) the block input for the particular time step and (ii) respective transformed block inputs generated by the neural network block for one or more preceding time steps that precede the current time step in the time step sequence.

In some implementations, i.e., when the block has OSD delay component, the system combines (i) the block input for the particular time step and (ii) only the respective transformed block input generated by the neural network block for the immediately preceding time step that immediately precedes the particular time step in the time step sequence to generate the block output for the particular time step.

For example, to combine (i) and (ii) the system can compute a sum of (i) and (ii) and, optionally, apply a non-linearity to the sum.

In some other implementations, i.e., when the block has an EWS delay component, the system combines (iii) the block input for the particular time step, (iv) the respective transformed block input for the particular time step and (v) the respective transformed block inputs generated by the neural network block for all preceding time steps that precede the particular time step in the time step sequence.

For example, to combine (iii), (iv), and (v), the system can compute an exponentially weighted smoothing sum of (iv) the respective transformed block input for the particular time step and (v) the respective transformed block inputs generated by the neural network block for all preceding time steps that precede the particular time step in the time step sequence and computing a sum of (iii) the block input for the particular time step and the exponentially weighted smoothing sum.

Optionally, the system can then apply a non-linearity to the sum to generate the block output.

Rather than computing the exponentially decayed smoothing sum from scratch at each time step, the system can compute the smoothing sum at each time step using an incremental update. In particular, the system can access a previous exponentially weighted smoothing sum that was computed at the immediately preceding time step and compute a sum of (i) the previous exponentially weighted smoothing sum weighted by a and (ii) the respective transformed block input for the particular time step weighted by (1−α), where α is a constant smoothing factor between zero and one.

In some cases, because of the delay components that cause the temporal delay within the parallel cascaded networks, the block input required to compute the transformed block input will not be available for some or all of the blocks at one or more earliest time steps in the sequence. In these cases, the block can operate on a predetermined state, e.g., a state of zero, or a learned initialization state in place of the block input. Similarly, for the first time step, there will be no preceding transformed block inputs for any of the blocks. The block can set these transformed block inputs to zero for the first time step.

In some cases, e.g., when all of the blocks and the initial layers have OSD delay components, the cascaded neural network is configured such that information will not propagate through the neural network at the first time step and the candidate network output at the first time step will therefore be based only on the initial states of the blocks. This can be the case in some configurations of the neural network when an initial layer of the neural network with no skip connection also operates with a time delay, e.g., has an OSD delay component.

In some other cases, however, the temporal delay is configured such that some information does propagate all the way through the neural network at the first time step and the candidate network output at the first time step is based on the network input. This can be the case in some configurations of the neural network when an initial layer of the neural network with no skip connection operates so that the output of the initial layer is based both on the time delay and the current input for the current time step, e.g., the one or more initial layers have an EWS delay component.

FIG. 4 is a flow diagram of an example process 400 training the parallel cascaded neural network. For convenience, the process 400 will be described as being performed by a system of one or more computers located in one or more locations. For example, a neural network system, e.g., the neural network system 100 of FIG. 1A, appropriately programmed, can perform the process 400.

The system can repeatedly perform the process 400 for multiple batches of training data.

The system obtains a batch of training data that includes one or more network inputs and a respective target output for each network input (step 402). The target output for a given network input is the ground truth output for the network input, i.e., the output that should be generated by performing the machine learning task on the network input. For example, the target output can be generated based on user-generated label for the network input or generated through auto-labelling techniques.

The system processes each network input in the batch using the parallel cascaded neural network and in accordance with current values of the parameters of the cascaded neural network to generate a respective network output for each network input (step 404). That is, the system processes each network input using the parallel cascaded neural network over a sequence of multiple time steps to generate a respective candidate network output for each time step as described above with reference to FIGS. 1-3. During training, rather than terminating the sequence based on one or more criteria, the system can continue processing each network input until information has fully propagated up through all of the layers in the neural network.

The system determines a gradient with respect to the parameters of the parallel cascaded neural network of a temporal difference loss (step 406).

The temporal difference loss measures, for each network input and at each time step in the sequence, a difference between (i) a temporal difference target for the time step and (ii) the candidate network output at the time step.

For example, the temporal difference loss can be equal to the average or sum over respective losses for each network input in the batch, where the respective loss for a given network input is a sum of cross-entropies for each time step in the sequence that each measure the cross-entropy between (i) a temporal difference target for the time step and (ii) the candidate network output at the time step.

Generally, the temporal difference target for a given time step (other than the last time step in the sequence) is based on the candidate network outputs for one or more time steps that are within a time horizon after the given time step in the sequence. For the last time step in the sequence, i.e., after information has fully propagated through the network, the temporal difference target is based on the target output for the network input. That is, rather than attempting to train the neural network to directly predict the network output at each time step even though information has not fully propagated up through the network until the last time step, the system instead trains the neural network using temporal differences.

In particular, the temporal difference target yₜ for a time step t satisfies:

$${y}_{t} = ( 1 - λ ) [ {\sum }_{i = 1}^{T - t} {λ}^{i - 1} {\hat{y}}_{t + i} ] + {λ}^{T - t} {y}_{true} ,$$

where λ is a hyperparameter that is greater than or equal to zero but less than one, Tis a fixed value for the time step t, yₜᵣᵤₑ is the target output, ŷₜ₊ᵢ is the candidate network output at time step t+i, and 0°, i.e., the value of zero raised to the power of zero, is considered to be equal to 1. In some cases, T can be equal to the total number of time steps in the sequence for all time steps while, in other cases, T can be equal to less than the total number of time steps in the sequence and can be different for different time steps, e.g., can be equal to the current time step index plus a fixed constant when truncated backpropagation through time is used.

Generally, the value for λ defines the time horizon for the temporal difference target, i.e., defines how quickly the influence of future candidate network outputs on the loss degrades.

When λ is set to zero, at each time step other than the last time step, the target is equal to the candidate network output at the immediately following time step and, at the last time step, the target is equal to the target output. When λ is set to 1, the network is trained in conventional fashion: at each time step, the network is trained to output the target.

By setting λ to be greater than or equal to zero but less than one, the system ensures that both future candidate network outputs and the target output influence the target at each time step other than the last time step in the sequence. In some implementations, λ is greater than zero but less than 0.5.

The system can compute the gradient of the temporal difference loss using a conventional technique, e.g., backpropagation through time or truncated backpropagation through time.

The system updates the current values of the parameters of the parallel cascaded neural network from the gradient (step 410). In particular, the system applies an optimizer, e.g., SGD, Adam, or rmsProp, to the gradient to update the current values of the parameters, i.e., to generate updated values of the parameters for use in the next iteration of the process 400.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a network input; and
generating a network output for the network input by, at each time step of a time step sequence comprising a plurality of time steps:
processing a time step input derived from the network input using a cascaded neural network to generate a candidate network output for the time step, wherein the cascaded neural network comprises a plurality of neural network blocks that are arranged in a stack one after another, and wherein each of the plurality of neural network blocks is configured to, for each particular time step of a plurality of particular time steps in the time step sequence:
receive a block input for the neural network block for the particular time step;
apply a learned block transformation to the block input for the particular time step to generate a transformed block input for the particular time step; and
generate a block output for the particular time step, comprising combining at least (i) the block input for the particular time step and (ii) respective transformed block inputs generated by the neural network block for one or more preceding time steps that precede the current time step in the time step sequence.

2. The method of claim 1, wherein the network output is the candidate network output for the last time step.

3. The method of claim 1, wherein generating the block output comprises combining (i) the block input for the particular time step and (ii) only the respective transformed block input generated by the neural network block for the immediately preceding time step that immediately precedes the particular time step in the time step sequence.

4. The method of claim 3, wherein generating the block output comprises:
computing a sum of (i) the block input for the particular time step and (ii) the respective transformed block input generated by the neural network block for the immediately preceding time step that immediately precedes the particular time step in the time step sequence.

5. The method of claim 4, wherein generating block output further comprises:
applying a non-linearity to the sum.

6. The method of claim 1, wherein generating the block output comprises combining (i) the block input for the particular time step, (ii) the respective transformed block input for the particular time step and (iii) the respective transformed block inputs generated by the neural network block for all preceding time steps that precede the particular time step in the time step sequence.

7. The method of claim 6, wherein generating the block output comprises:
computing an exponentially weighted smoothing sum of the (ii) the respective transformed block input for the particular time step and (iii) the respective transformed block inputs generated by the neural network block for all preceding time steps that precede the particular time step in the time step sequence; and
computing a sum of the block input for the particular time step and the exponentially weighted smoothing sum.

8. The method of claim 7, wherein generating block output further comprises:
applying a non-linearity to the sum.

9. The method of claim 7, wherein computing the exponentially weighted smoothing sum comprises:
accessing a previous exponentially weighted smoothing sum that was computed at the immediately preceding time step; and
computing a sum of (i) the previous exponentially weighted smoothing sum weighted by a and (ii) the respective transformed block input for the particular time step weighted by (1−α), wherein α is a constant smoothing factor between zero and one.

10. The method of claim 1, wherein the time step input for each time step in the sequence is the network input.

11. The method of claim 1, wherein the network input changes over time and each time step input is the network input as of a corresponding time point.

12. The method of claim 11, wherein each time step input is an image of a scene taken at the corresponding time point or a video frame at the corresponding time point in a video.

13. The method of claim 1, wherein, for each time step and for each block after the first block in the stack, the block input is the block output of the preceding block in the stack for the time step.

14. The method of claim 1, wherein, for each time step and for the first block in the stack, the block input is the time step input for the time step.

15. The method of claim 1, wherein, for each time step and for the first block in the stack, the block input is one of:
an output of one or more initial layers of the neural network for the time step and generated by processing the time step input for the time step;
an output of one or more initial layers of the neural network for the immediately preceding time step and generated by processing the time step input for the immediately preceding time step; or
a combination of the output of one or more initial layers of the neural network for the time step and generated by processing the time step input for the time step and respective outputs of the one or more initial layers of the neural network for one or more preceding time steps that are each generated by processing the time step input for the preceding time step.

16. The method of claim 1, further comprising:
determining that criteria for terminating processing of the network input have been satisfied; and
in response, refraining from processing for any time steps after the last time step in the sequence and selecting the candidate network output for the last time step in the sequence as the network output.

17. The method of claim 16, wherein determining that criteria for terminating processing of the network input have been satisfied comprises determining that the criteria have been satisfied from (i) the candidate network outputs, (ii) intermediate logits generated by the cascaded neural network, or both for at least some of the time steps in the sequence.

18. The method of claim 17, wherein determining that criteria are satisfied comprises processing an input derived from (i) the candidate network outputs, (ii) intermediate logits generated by the cascaded neural network, or both for at least some of the time steps in the sequence using a meta-cognitive machine learning model that has been trained to predict whether the last candidate network output should be selected as the network output.

19. The method of claim 1, further comprising:
detecting, based on (i) the candidate network outputs, (ii) intermediate logits generated by the cascaded neural network, or both for at least some of the time steps in the sequence, whether the network input is an out-of-distribution (OOD) input.

20. The method of claim 19, wherein the detecting comprises processing an input derived from (i) the candidate network outputs, (ii) intermediate logits generated by the cascaded neural network, or both for at least some of the time steps in the sequence using a meta-cognitive machine learning model that has been trained to predict whether the network input is an OOD input.

21. The method of claim 1, wherein the network input is obtained during training, and wherein the method further comprises:
obtaining a target output for the network input;
determining, through backpropagation through time, a gradient with respect to the parameters of the cascaded neural network of a temporal difference loss that measures, at each time step in the sequence, a difference between a temporal difference target for the time step and the candidate network output at the time step; and
determining an update to the parameters of the cascaded neural network from the gradient.

22. The method of claim 21, wherein for each time step t, the temporal difference target yₜ satisfies:
$${y}_{t} = ( 1 - λ ) [ {\sum }_{i = 1}^{T - t} {λ}^{i - 1} {\hat{y}}_{t + i} ] + {λ}^{T - t} {y}_{true} ,$$
wherein T is the total number of time steps in the sequence, yₜᵣᵤₑ is the target output, and ŷₜ₊ᵢ is the candidate network output at time step t+1.

23. The method of claim 22, wherein λ is greater than or equal to zero but less than one.

24. The method of claim 22, wherein λ is less than 0.5.

25. The method of claim 1, wherein each block is deployed on respective dedicated hardware for the block.

26. One or more non-transitory computer-readable media storing instructions that when executed by one or more computers cause the one or more computers to perform operations comprising:
obtaining a network input; and
generating a network output for the network input by, at each time step of a time step sequence comprising a plurality of time steps:
processing a time step input derived from the network input using a cascaded neural network to generate a candidate network output for the time step, wherein the cascaded neural network comprises a plurality of neural network blocks that are arranged in a stack one after another, and wherein each of the plurality of neural network blocks is configured to, for each particular time step of a plurality of particular time steps in the time step sequence:
receive a block input for the neural network block for the particular time step;
apply a learned block transformation to the block input for the particular time step to generate a transformed block input for the particular time step; and
generate a block output for the particular time step, comprising combining at least (i) the block input for the particular time step and (ii) respective transformed block inputs generated by the neural network block for one or more preceding time steps that precede the current time step in the time step sequence.

27. A system comprising one or more computers and one or more storage devices storing instructions that when executed by the one or more computers cause the one or more computers to perform operations comprising:
obtaining a network input; and
generating a network output for the network input by, at each time step of a time step sequence comprising a plurality of time steps:
processing a time step input derived from the network input using a cascaded neural network to generate a candidate network output for the time step, wherein the cascaded neural network comprises a plurality of neural network blocks that are arranged in a stack one after another, and wherein each of the plurality of neural network blocks is configured to, for each particular time step of a plurality of particular time steps in the time step sequence:
receive a block input for the neural network block for the particular time step;
apply a learned block transformation to the block input for the particular time step to generate a transformed block input for the particular time step; and
generate a block output for the particular time step, comprising combining at least (i) the block input for the particular time step and (ii) respective transformed block inputs generated by the neural network block for one or more preceding time steps that precede the current time step in the time step sequence.
